(19) United States
(12) Patent Application Publication
(10) Pub. No.: US 2015/0269840 A1
(43) Pub. Date: Sep. 24, 2015

(54) PROBE DATA PROCESSING APPARATUS, PROBE DATA PROCESSING METHOD, PROGRAM, AND PROBE DATA PROCESSING SYSTEM

(71) Applicant: Mitsubishi Electric Corporation, Chiyoda-ku, Tokyo (JP)

(72) Inventor: Takahisa Hirata, Tokyo (JP)

(73) Assignee: Mitsubishi Electric Corporation, Chiyoda-ku, Tokyo (JP)

(21) Appl. No.: 14/434,340

(22) PCT Filed: Jul. 31, 2013
(86) PCT No.: PCT/JP2013/070748

§ 371 Date: Apr. 8, 2015

(30) Foreign Application Priority Data
Nov. 19, 2012 (JP) 2012-253373

(51) Int. Cl. G08G 1/01

(52) U.S. Cl. CPC G08G 1/0133

(57) ABSTRACT

In probe data tallying, tallying with a high-resolution spatial granularity is enabled, and high-precision tallying is enabled by suppressing loss of the information quantity of the probe data. A data recording part records probe data generated by a vehicle, which is a probe. A filter coefficient recording part associates filter coefficients determined depending on distances between a road, which is a geographic element existing in a geographic range segmented into a plurality of regions, and the plurality of regions, with the plurality of regions, respectively, and records the filter coefficients. A filter computation processing part selects regions corresponding to the probe data recorded by the data recording part, respectively, from among the plurality of regions, reads the filter coefficients associated with the selected regions and recorded by the filter coefficient recording part, respectively, weights the probe data with the filter coefficients, respectively, and tallies the probe data.

### TECHNICAL FIELD

The present invention relates to a probe data processing apparatus, a probe data processing method, a program, and a probe data processing system.

### BACKGROUND ART

Regarding a telematics technology that aggregates and utilizes information (to be referred to as “probe data” hereinafter) obtained by a plurality of sensors (to be referred to as “probes” hereinafter) arranged in a distributed way, there is a demand for associating probe data and map information, and performing tallying. For example, where a vehicle is employed as a probe and a vehicle position and speed are treated as probe data, the telematics technology has a use of associating a specific road on a map and vehicles passing on the road based on the vehicle positions, and tallying the vehicle speed on the specific road, so that the traffic jam degree is estimated from the distribution of the vehicle speed.

As a technique related to conventional probe data tallying, for example, techniques described in Patent Literature 1 and 2 are available.

Patent Literature 1 discloses, in a case of estimating the existence or nonexistence of a traffic jam at a specific point based on the probe data, a method of determining the existence or nonexistence of the traffic jam on the probe side and transmitting the determination result to the server, so that tallying on the server side becomes unnecessary in estimating the existence or nonexistence of the traffic jam.

Patent Literature 2 discloses, in a case of associating the probe data and the road and performing tallying, a method of saving the associating relation between an imaginary road called arc and the position information of probe data formed of a latitude and longitude called grid, in the form of a list, so that tallying can be performed at a high speed.

### CITATION LIST

### Patent Literature

Patent Literature 1: JP 2011-133413 A
Patent Literature 2: WO 2008/117787 A1

### SUMMARY OF INVENTION

### Technical Problem

The prior art has a problem that it requires, as a premise, that when tallying the probe data by the server side process, the associating relation in tallying should be definable with a sufficiently high precision. Hence, a problem arises in the prior art that if the associating relation includes uncertainty, there may be a gap between the tallied result and the actual state. Particularly, if there is a demand for a higher resolution in the spatial granularity of the tallying unit, this demand cannot be met because the uncertainty of the associating relation enlarges relatively as the resolution of the tallying unit increases.

Patent Literature 1 describes an example in which probe data is used by the probe side process. In this example, traffic jam existence or nonexistence calculated by the probe is transmitted to the server, and the transmitted information is updated by overwriting on the server side, so that the traffic jam information is managed. Although this scheme is effective in decreasing the processing quantity of the server side, a problem of information quantity loss occurs because information obtained from a large number of probes is overwritten with information from a specific probe.

For example, assume that a plurality of probes have passed a specific road within a short period of time. If there is no traffic jam at all, as the determination result of the traffic jam existence or nonexistence by the probes, all the probes will determine that there is no traffic jam; if there is a heavy traffic jam, all the probes will determine that there is a traffic jam. In general, however, a transient circumstance is anticipated as an intermediate stage where one probe determines there is no traffic jam while another probe determines there is a traffic jam. In this circumstance, if the determination depends on the data processing at each probe, information from another probe cannot be referred to. Then, a problem arises that an improvement in the determination precision on the traffic jam existence or nonexistence cannot be expected even when the number of probes increases. In this respect, if the tallying is performed on the server side, probe data from a plurality of probes are associated with the road and aggregated. Then, an effect is expected such as enabling calculation of a stepwise index representing the degree of the traffic jam.

Patent Literature 2 describes an example in which probe data is used in server-side processing. In this example, the associating relation between the road and the grids expressing the probe positions is known in advance and managed in the form of a list, so that tallying with relating the road and the probe data to each other is realized. This scheme is effective if the target is a major road or the like that can be expressed by coarse grids. If, however, the target is a residential street or the like for which fine grids are required, the problem of uncertainty described above arises.

For example, acquisition of the position information of a probe is assumed to be conducted by measurement using the GPS (Global Positioning System). The positional precision of the GPS is said to be several meters to several tens of meters. When grids of a granularity lower than this precision range are employed, grids corresponding to the actual probe positions and grids corresponding to the measured probe positions do not necessarily coincide. Therefore, a problem of a gap between the tallied result and the actual state arises (see FIG. 10). Likewise, the road position information includes an error of approximately several meters. A minor road position shift due to land readjustment or the like necessitates updating the road position information. As a result of these and other issues, if the grid granularity becomes finer, a problem of difficulty in accurately defining the associating relation between the road and the grids arises (see FIG. 11).

In this manner, in order to utilize the probe data effectively, it is necessary for the server side to associate the probe data and the map information, and perform tallying. Preferably, such tallying should be possible with a high-resolution spatial granularity as well. The prior art, however, has a problem that tallying with a high-resolution spatial granularity cannot be performed.

It is, for example, an object of the present invention in probe data tallying to enable tallying with a high-resolution spatial granularity, and enable high-precision tallying by suppressing loss of the information quantity of the probe data.

### Solution to Problem

A probe data processing apparatus according to one aspect of the present invention includes:

a data recording part that records a plurality of pieces of probe data generated by a probe which observes a specific event and indicating observation positions and observation values, to a storage device;

a filter coefficient recording part that associates filter coefficients determined depending on distances between a geographic element existing in a geographic range segmented into a plurality of regions, and the plurality of regions, with the plurality of regions, respectively, and records the filter coefficients to the storage device; and

a filter computation processing part that reads the plurality of pieces of probe data recorded by the data recording part from the storage device, selects regions corresponding to the observation positions indicated by the plurality of pieces of probe data, respectively, from among the plurality of regions, reads the filter coefficients associated with the selected regions and recorded by the filter coefficient recording part, respectively, from the storage device, weights the observation values indicated by the plurality of pieces of probe data, with the filter coefficients that are read, respectively, and tallies the observation values that are weighted.

### Advantageous Effects of Invention

According to one aspect of the present invention, observation values indicated by a plurality of pieces of probe data are weighted with filter coefficients which are determined depending on distances between regions corresponding to observation positions indicated by the plurality of pieces of probe data, respectively, and a certain geographic element, and the weighted observation values are tallied. Hence, in probe data tallying, tallying with a high-resolution spatial granularity is enabled. Also, high-precision tallying is enabled by suppressing loss of the information quantity of the probe data.

### BRIEF DESCRIPTION OF DRAWINGS

FIG. 1 is a block diagram illustrating a configuration of a probe data processing system according to Embodiment 1.

FIG. 2 is a diagram indicating a recording example of probe data according to Embodiment 1.

FIG. 3 is a diagram indicating a recording example of map information according to Embodiment 1.

FIG. 4 is a diagram illustrating an example in which the magnitude of filter coefficients according to Embodiment 1 is expressed by light-dark contrasts.

FIG. 5 is a diagram indicating a recording example of the filter coefficients according to Embodiment 1.

FIG. 6 is a diagram illustrating an example of the hardware configuration of a probe data processing apparatus according to Embodiment 1.

FIG. 7 is a flowchart illustrating the operation of the probe data processing apparatus according to Embodiment 1.

FIG. 8 is a flowchart illustrating the operation of the probe data processing apparatus according to Embodiment 1.

FIG. 9 is a flowchart illustrating the operation of the probe data processing apparatus according to Embodiment 1.

FIG. 10 indicates a problem in the prior art.

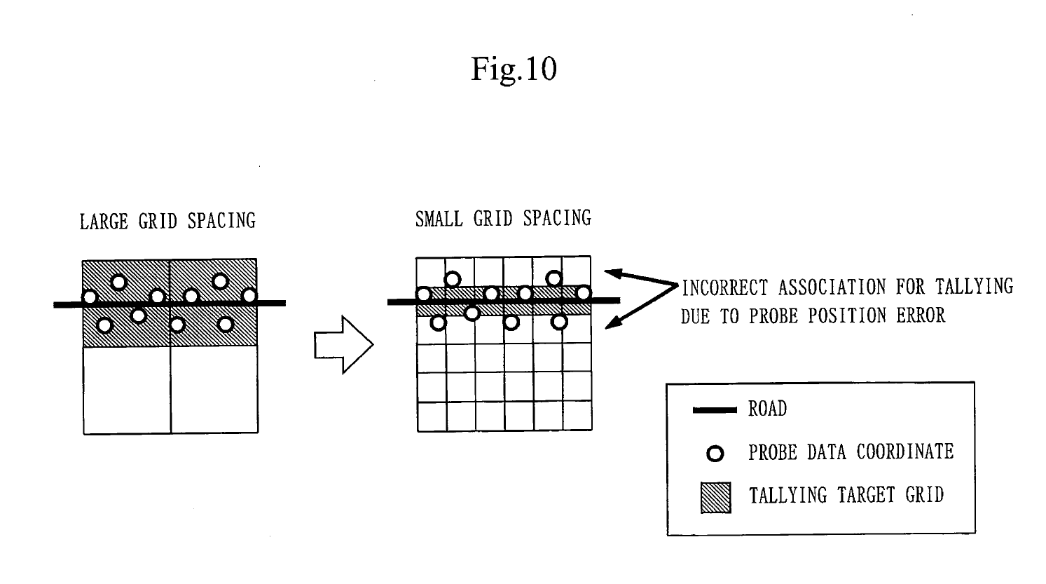

FIG. 11 indicates a problem in the prior art.

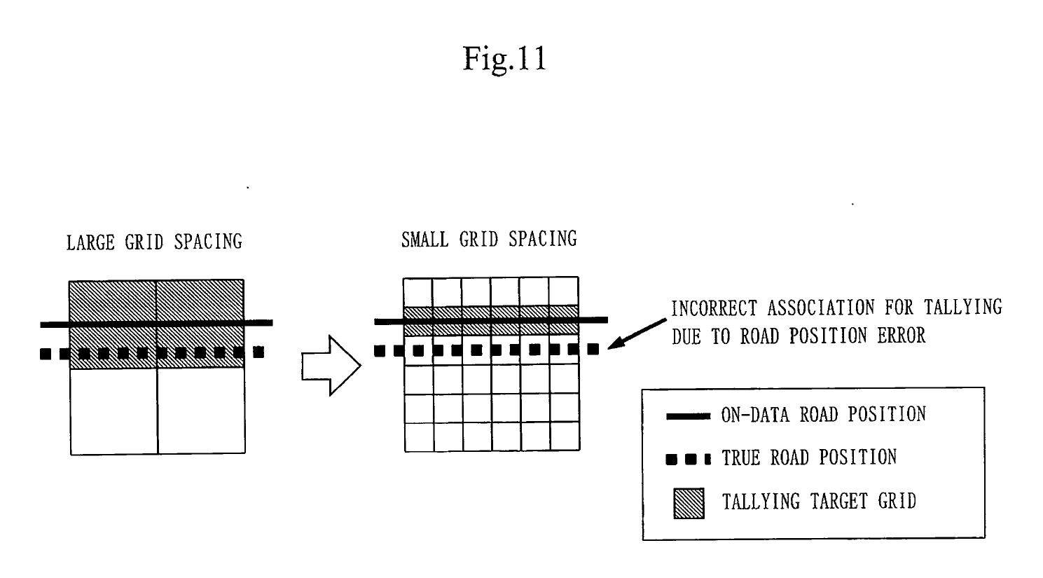

### DESCRIPTION OF EMBODIMENTS

An embodiment of the present invention will be described hereinafter with reference to accompanying drawings.

### Embodiment 1

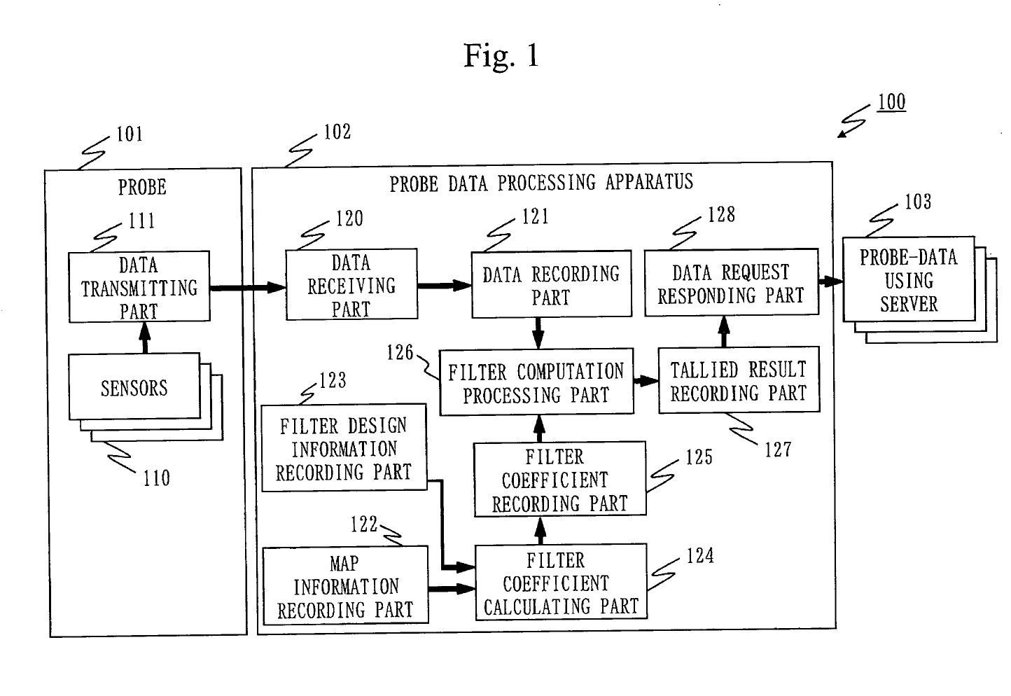

FIG. 1 is a block diagram illustrating a configuration of a probe data processing system 100 according to this embodiment.

Referring to FIG. 1, the probe data processing system 100 has a probe 101, a probe data processing apparatus 102, and a probe-data using server 103.

The probe 101 observes a specific event, generates probe data, and transmits the generated probe data to the probe data processing apparatus 102. The probe data is data indicating a position (namely, an observation position) where the probe 101 observed the specific event, an observation value obtained by the probe 101 through observation of the specific event, and the attribute of a geographic element (namely, an observation location) where the probe 101 observed the specific event.

The probe data processing apparatus 102 receives a plurality of pieces of probe data transmitted from one or a plurality of probes 101, tallies the plurality of pieces of received probe data, and supplies the tallied result to the probe-data using server 103.

Using the tallied result of the plurality of pieces of probe data supplied by the probe data processing apparatus 102, the probe-data using server 103 provides services.

According to an example, a vehicle traveling on a road (an example of the geographic element) can be treated as the probe 101.

In this case, the vehicle, which is the probe 101, observes the vehicle speed, a traffic jam of the road, and the like (examples of the specific event) at a predetermined time or at a predetermined point. Each time the vehicle observes the vehicle speed, a traffic jam of the road, and the like, the vehicle generates probe data indicating the latitude and longitude of the current position (examples of the observation position); the vehicle speed, the traffic jam degree of the road, and the like (examples of the observation value); and the lane direction, the road type, and the like (examples of the attribute of the observation location) of the road on which the vehicle is traveling.

The probe data processing apparatus 102 collects a plurality of pieces of probe data from one or a plurality of vehicles, tallies the plurality of pieces of collected probe data, and supplies the tallied result to the probe-data using server 103.

Using the tallied result of the plurality of pieces of probe data provided by the probe data processing apparatus 102, the probe-data using server 103 provides a road information guide service and the like.

According to another example, a server computer installed on a rack (an example of the geographic element) in a server room can be treated as the probe 101.

In this case, the server computer, which is the probe 101, observes the processing speed, the ambient temperature, and the like (examples of the specific event) at a predetermined time. Each time the server computer observes the processing speed, the ambient temperature, and the like, the server computer generates probe data indicating the identification numbers of the server room and the rack (an example of the observation position); the processing speed, the ambient temperature, and the like (examples of the observation value); and the preset air-conditioning temperature of the server room, and the like (examples of the attribute of the observation location).

The probe data processing apparatus 102 collects a plurality of pieces of probe data from a plurality of server computers, tallies the plurality of pieces of collected probe data, and supplies the tallied result to the probe-data using server 103.

Using the tallied result of the plurality of pieces of probe data provided by the probe data processing apparatus 102, the probe-data using server 103 provides a server supervisory control service and the like.

According to still another example, an equipment instrument installed on a power pole (an example of the geographic element) can be treated as the probe 101.

In this case, the equipment instrument, which is the probe 101, observes the operation status and the like (examples of the specific event) of the equipment instrument at a predetermined time. Each time the equipment instrument observes the operation status and the like of the equipment instrument, the equipment instrument generates probe data indicating the latitude and longitude of the existing position (an example of the observation position) of the power pole, and the operation status and the like (examples of the observation value) of the equipment instrument. The probe data may also indicate some attribute (an example of the attribute of the observation location) of the power pole.

The probe data processing apparatus 102 collects a plurality of pieces of probe data from a plurality of equipment instruments, tallies the plurality of pieces of collected probe data, and supplies the tallied result to the probe-data using server 103.

Using the tallied result of the plurality of pieces of probe data provided by the probe data processing apparatus 102, the probe-data using server 103 provides a remote maintenance service and the like.

Various other mobile bodies, instruments, and the like can be treated as the probe 101.

This embodiment will be described hereinafter mainly by referring to a case in which a vehicle is the probe 101. If another case is adopted, the basic configuration and operation of the probe 101, probe data processing apparatus 102, and probe-data using server 103 are the same.

The probe 101 has sensors 110 and a data transmitting part 111.

The sensors 110 measure physical quantities such as the position, speed, and traveling direction, and estimated quantities such as the road surface condition and the traffic jam degree, as the specific event.

The data transmitting part 111 transmits data measured by the sensors 110 to the probe data processing apparatus 102 via an arbitrary communication means. The data transmitting part 111 transmits the probe data in accordance with a condition determined with the probe data processing apparatus 102 in advance. For example, the data transmitting part 111 transmits the probe data at predetermined intervals, at an event occurrence, or the like.

The probe data processing apparatus 102 has a data receiving part 120, a data recording part 121, a map information recording part 122, a filter design information recording part 123, a filter coefficient calculating part 124, a filter coefficient recording part 125, a filter computation processing part 126, a tallied result recording part 127, and a data request responding part 128.

Although not illustrated in FIG. 1, the probe data processing apparatus 102 has hardware such as a processing device, a storage device, an input device, and an output device. The hardware is utilized by each part of the probe data processing apparatus 102. For example, the processing device is utilized by each part of the probe data processing apparatus 102 for performing computation, processing, reading, writing, and the like of the data and information. The storage device is utilized for storing the data and information. The input device is utilized for inputting the data and information. The output device is utilized for outputting the data and information.

The data receiving part 120 receives the probe data transmitted from the data transmitting part 111 of the probe 101.

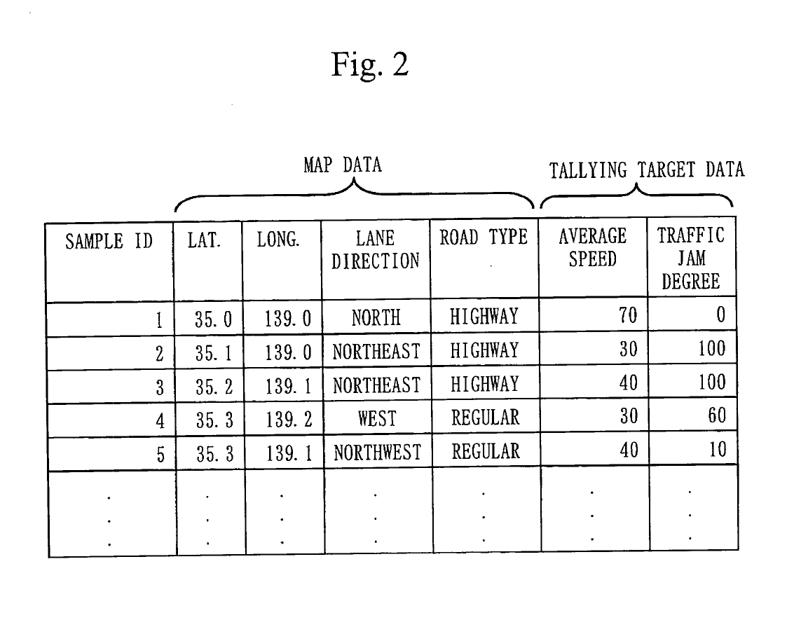

The data recording part 121 records the probe data received by the data receiving part 120 to the storage device. The data recording part 121 is preferably capable of permanently recording all the probe data received by the data receiving part 120, but may temporarily hold only information necessary for updating of the tallied result recording part 127. FIG. 2 indicates a recording example of the probe data. The probe data consists of at least map data for storing values to be collated with the map information, and tallying target data for storing values to be tallied. The information recorded in the map data preferably includes information recorded by the map information recording part 122, but does not necessarily include all information to the extent that can be complemented by the filter coefficient calculating part 124.

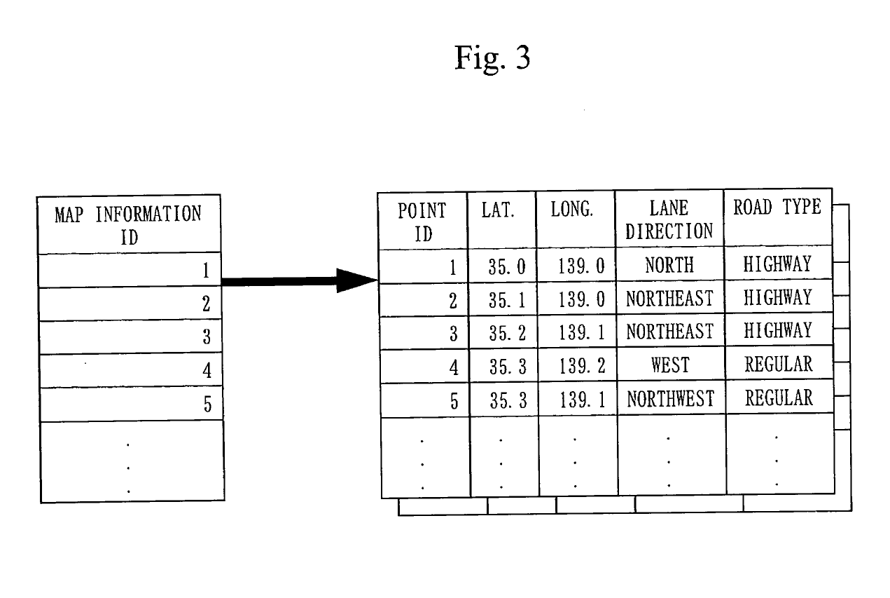

The map information recording part 122 records the map information serving for tallying the probe data to the storage device. The map information means not only the position and azimuth within the three-dimensional space but also an arbitrary variable that can be utilized as a tallying condition. For example, when performing tallying by associating the road and the probe 101 which is a vehicle, the map information includes traffic constraint information such as the speed and traveling direction allowed at each point, road type information as to whether the road is a highway or a regular road, and so on, in addition to the position information constituting the road. FIG. 3 indicates a recording example of the map information.

The filter design information recording part 123 records a parameter serving for calculating filter coefficients, to the storage device.

The filter coefficient calculating part 124, with respect to the map information recorded by the map information recording part 122, calculates the filter coefficients by the processing device using the parameter recorded by the filter design information recording part 123. The filter coefficients are calculated based on the distances between the probe data and the map information, and is used as weight coefficients when tallying the probe data. The distances refer to distances within a general multi-dimensional space, which are mathematically defined as norms, and are not limited to a specific measure such as Euclidean distances. This is apparent from the definition of the map information as well. For example, a filter coefficient calculation formula as follows can be used.

$${d}_{j} = {min}_{i} ( D ( {p}_{j} , {q}_{i} ) ) \qquad [ Formula 1 ]$$

dⱼ: filter coefficient at a filter coefficient calculation target point j
pⱼ: map information parameter at the filter coefficient calculation target point j
qⱼ: map information parameter at point IDᵢ
D(•,•): distance function

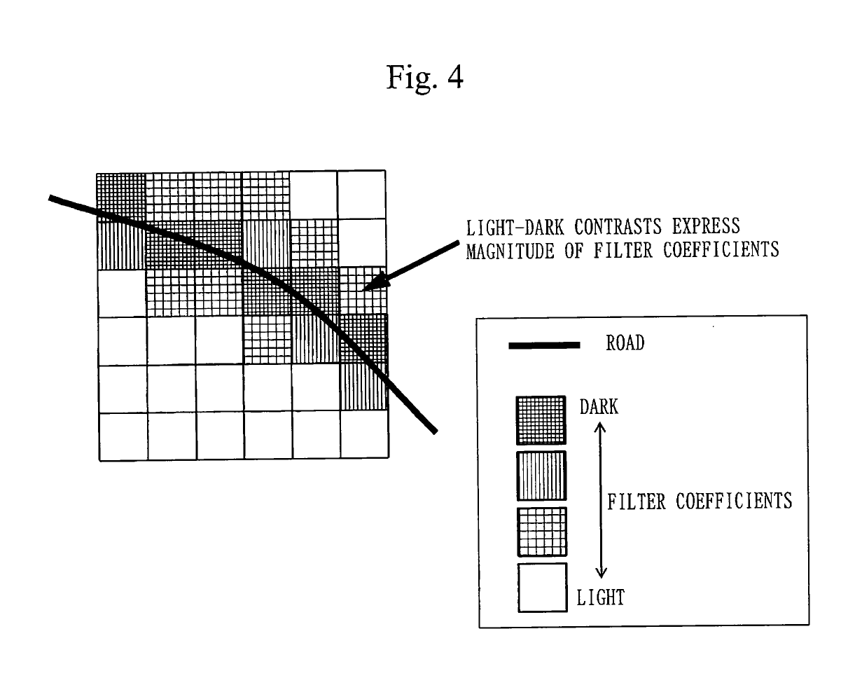

FIG. 4 illustrates an example in which the magnitude of the filter coefficients calculated based on the two-dimensional distances from the road is expressed by light-dark contrasts. When the filter coefficients are set in this manner, probe data that falls outside the road can also be included in the tallying, and an effect of suppressing contribution of a point that is far from the road can be obtained.

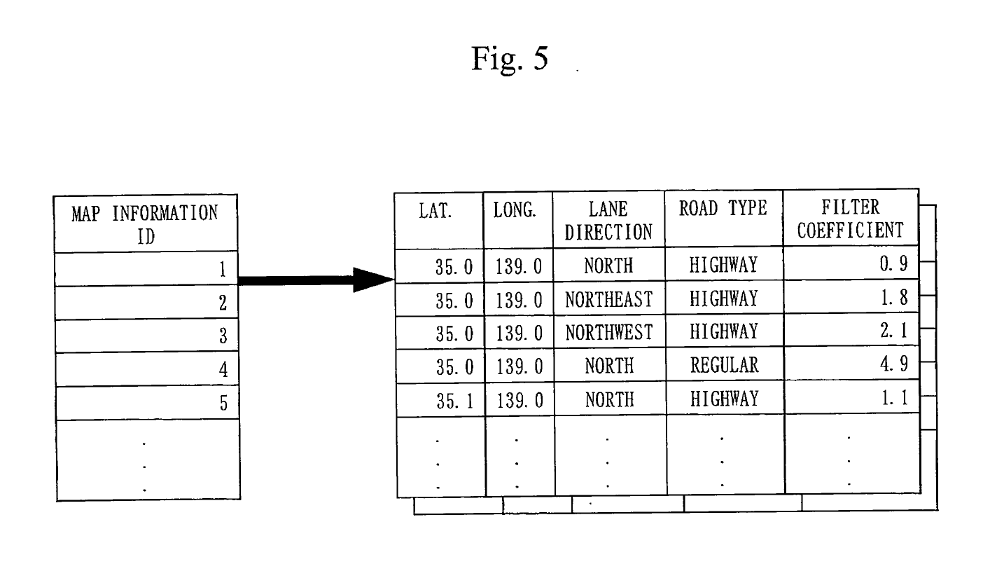

The filter coefficient recording part 125 records the filter coefficients calculated by the filter coefficient calculating part 124 to the storage device. FIG. 5 indicates a recording example of the filter coefficients. Filter coefficient calculation requires calculation of distances with respect to all point IDs (IDentifiers), leading to a high calculation load. In view of this, the map information is segmented into grids, and the filter coefficients of the respective grids are calculated and recorded in advance, so that an effect of reducing the calculation load of the filter computation can be obtained. For the sake of high-speed collation, the filter coefficient recording part 125 preferably sets a threshold for the filter coefficients, and, with respect to a grid which is at a certain distance or more, excludes a filter coefficient from being recorded. Also, the filter coefficient recording part 125 preferably, for a higher collation hit rate, rearranges the filter coefficients in an ascending order and records the rearranged filter coefficients, or employs a recording method using a binary tree scheme or the like. Note that the purpose of the filter coefficient recording part 125 is to eliminate repetition of a filter coefficient calculating process. If the density of the map information or probe data is sufficiently small, instead of providing the filter coefficient recording part 125, the filter coefficient may be calculated whenever necessary. In that case, a filter coefficient corresponding to the probe data is calculated by replacing a filter coefficient calculation target point in the filter coefficient calculation formula described above with tallying target probe data.

The filter computation processing part 126, with respect to the probe data recorded by the data recording part 121, extracts a filter coefficient corresponding to the probe data from among the filter coefficients recorded by the filter coefficient recording part 125, and performs the tallying process by the processing device using the extracted filter coefficient. Filter computation may be an arbitrary computation that uses the distance as the weight. For example, the filter computation includes calculation of a statistic such as a mean value or variance, estimation of a sample distribution, prediction by regression, and the like. The mean value can be calculated by, for example, a filter computation formula as follows.

$$S = ( {\sum }_{i} {s}_{i} {e}^{- {d}_{i}} ) / ( {\sum }_{i} {e}^{- {d}_{i}} ) \qquad [ Formula 2 ]$$

S: tallied result of mean values by filter computation
dᵢ: filter coefficient of tallying target probe data
sᵢ: tallying target value of tallying target probe data i

The tallied result recording part 127 records the tallying process result calculated by the filter computation processing part 126 to the storage device.

In response to an inquiry from the probe-data using server 103, the data request responding part 128 supplies the tallied result recorded by the tallied result recording part 127.

As described above, in this embodiment, the data recording part 121 records a plurality of pieces of probe data generated by a vehicle, which is an example of the probe 101, and indicating observation positions (for example, the latitude and longitude of the current position) and observation values (for example, the vehicle speed and the traffic jam degree of a road), to the storage device. The filter coefficient recording part 125 associates filter coefficients determined depending on distances between a road, which is an example of a geographic element existing in a geographic range segmented into a plurality of regions (for example, girds), and the plurality of regions, with the plurality of regions, respectively, and records the filter coefficients to the storage device. The filter computation processing part 126 reads the plurality of pieces of probe data recorded by the data recording part 121 from the storage device, and selects regions corresponding to the observation positions indicated by the plurality of pieces of probe data, respectively, from among the plurality of regions. The filter computation processing part 126 reads the filter coefficients associated with the selected regions and recorded by the filter coefficient recording part 125, respectively, from the storage device. The filter computation processing part 126 weights the observation values indicated by the plurality of pieces of probe data, with the filter coefficients that are read, respectively, and tallies the observation values that are weighted.

According to this embodiment, the observation values of the probe data are weighted with the filter coefficients that depend on the distances between the road and the observation points (regions corresponding to the observation positions) of the probe data. Hence, in the probe data tallying, tallying with a high-resolution spatial granularity is enabled. Also, high-precision tallying is enabled by suppressing loss of the information quantity of the probe data.

In this embodiment, the data recording part 121 records the plurality of pieces of probe data indicating an attribute (for example, a lane direction, a road type, or their combination) of an observation location, in addition to the observation positions and the observation values. The filter coefficient recording part 125 associates the filter coefficients determined depending on distances between an attribute of the road and a plurality of attributes (for example, whether the lane direction is north, south, east or west, whether the road type is highway or regular road), in addition to the distances between the road and the plurality of regions, with combinations of the plurality of regions and the plurality of attributes, respectively, and records the filter coefficients. The filter computation processing part 126 reads the plurality of pieces of probe data recorded by the data recording part 121 from the storage device, and, in addition to selecting the regions corresponding to the observation positions indicated by the plurality of pieces of probe data, respectively, from among the plurality of regions, selects an attribute that matches the attribute of the observation value indicated by the plurality of pieces of probe data, respectively, from among the plurality of attributes. The filter computation processing part 126 reads the filter coefficients associated with combinations of the selected regions and the selected attribute and recorded by the filter coefficient recording part 125, respectively. The filter computation processing part 126 weights the observation values indicated by the plurality of pieces of probe data, with the filter coefficients, respectively, and tallies the observation values that are weighted.

According to this embodiment, the observation value of the probe data is weighted with the filter coefficients that depend not only on the geographic distances between the road and the observation points of the probe data, but also on the mathematical distances between the attribute of the road and the attribute of the observation points of the probe data. Therefore, in probe data tallying, further high-precision tallying is possible.

If the plurality of pieces of probe data that are read include probe data in which the observation value exceeds the speed limit of the road, the filter computation processing part 126 may, for the probe data, increase the filter coefficient and thereafter weight the observation value. In this case, an influence by an observation result from a vehicle that exceeds the speed limit is suppressed, so that a more appropriate tallied result can be obtained.

The filter coefficient recording part 125 may, with respect to a region which is at a certain distance or more from the road, exclude a filter coefficient from being recorded. In this case, an influence by an observation result from a vehicle with a low measuring precision (or having a deficiency in the measuring function) is suppressed, so that a further high-precision tallied result can be obtained.

The filter computation processing part 126 may, for selecting the regions, extracts the regions corresponding to the observation positions indicated by the plurality of pieces of probe data that are read, respectively, from among the plurality of regions, by collating the plurality of regions to the observation positions indicated by the plurality of pieces of probe data, in an ascending order of the filter coefficients recorded by the filter coefficient recording part 125. In this case, the filter computation processing part 126 can specify the filter coefficients corresponding to the respective observation points of the probe data more quickly. In particular, a large effect can be obtained when the number of combinations of the regions and the attributes is enormous (for example, in FIG. 5, for just one region with the latitude of 35.0 and the longitude of 139.0, there are as many as four combinations of different lane directions and road types).

The plurality of regions may be set to have different sizes depending on a geographic condition. For example, in a geographic range where the road exists, a portion corresponding to an urban area may be segmented more finely than a portion corresponding to a rural area. In that case, a further high-precision tallied result can be obtained.

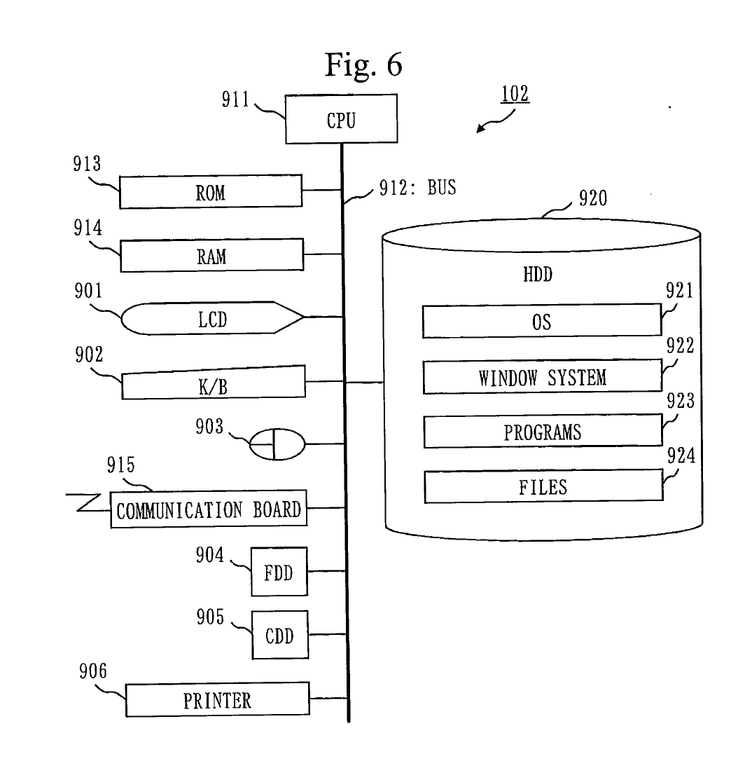

FIG. 6 illustrates an example of the hardware configuration of the probe data processing apparatus 102.

Referring to FIG. 6, the probe data processing apparatus 102 is a computer and has hardware devices such as an LCD 901 (Liquid Crystal Display), a keyboard 902 (K/B), a mouse 903, an FDD 904 (Flexible Disk Drive), a CDD 905 (Compact Disc Drive), and a printer 906. These hardware devices are connected to each other via cables or signal lines. In place of the LCD 901, a CRT (Cathode Ray Tube) or another display device may be employed. In place of the mouse 903, a touch panel, a touch pad, a track ball, a pen tablet, or another pointing device may be employed.

The probe data processing apparatus 102 has a CPU 911 (Central Processing Unit) which executes programs. The CPU 911 is an example of the processing device. The CPU 911 is connected to a ROM 913 (Read Only Memory), a RAM 914 (Random Access Memory), a communication board 915, the LCD 901, the keyboard 902, the mouse 903, the FDD 904, the CDD 905, the printer 906, and an HDD 920 (Hard Disk Drive) via a bus 912, and controls these hardware devices. In place of the HDD 920, a flash memory, an optical disc device, a memory card reader/writer, or another recording medium may be employed.

The RAM 914 is an example of a volatile memory. The ROM 913, FDD 904, CDD 905, and HDD 920 are examples of a nonvolatile memory. These memories are examples of the storage device. The communication board 915, keyboard 902, mouse 903, FDD 904, and CDD 905 are examples of the input device. Also, the communication board 915, LCD 901, and printer 906 are examples of the output device.

The communication board 915 is connected to a LAN (Local Area Network) or the like. Other than the LAN, the communication board 915 may be connected to a WAN (Wide Area Network) such as an IP-VPN (Internet Protocol Virtual Private Network), a wide area LAN, or an ATM (Asynchronous Transfer Mode) network; or the Internet. The LAN, WAN, and Internet are examples of a network.

The HDD 920 stores an operating system 921 (OS), a window system 922, programs 923, and files 924. The CPU 911, operating system 921, and window system 922 execute each program of the programs 923. The programs 923 include a program that executes the function described as a “part” in the description of this embodiment. The program is read and executed by the CPU 911. The files 924 include data, information, signal values, variable values, and parameters described as “data”, “information”, “ID (identifier)”, “flag”, or “result” in the description of this embodiment, as the items of a “file”, “database”, and “table”. The “file”, “database”, and “table” are stored in a recording medium such as the RAM 914 or HDD 920. The data, information, signal values, variable values, and parameters stored in the recording medium such as the RAM 914 or HDD 920 are read into the main memory or cache memory by the CPU 911 through a read/write circuit, and are used for the processing (operation) of the CPU 911 such as extraction, search, look-up, comparison, computation, calculation, control, output, print, and display. The data, information, signal values, variable values, and parameters are temporarily stored in the main memory, cache memory, or buffer memory during the processing of the CPU 911 such as extraction, search, look-up, comparison, computation, calculation, control, output, print, and display.

The arrows in the block diagrams and flowcharts used in the description of this embodiment mainly indicate input/output of data and signals. The data and signals are recorded in the memory such as the RAM 914, the flexible disk (FD) of the FDD 904, the compact disc (CD) of the CDD 905, the magnetic disk of the HDD 920, an optical disc, a DVD (Digital Versatile Disc), or another recording medium. The data and signals are transmitted via the bus 912, the signal lines, the cables, or another transmission medium.

What is described as a “part” in the description of this embodiment may be a “circuit”, “device”, or “appliance”; or a “step”, “process”, “procedure”, or “processing”. Namely, what is described as a “part” may be implemented as firmware stored in the ROM 913. Alternatively, what is described as “part” may be implemented only as software; only as hardware such as an element, a device, a substrate, or a wiring line; as a combination of software and hardware; or as a combination of software, hardware, and firmware. The firmware and software are stored, as programs, in a recording medium such as the flexible disk, compact disc, magnetic disk, optical disc, or DVD. The program is read by the CPU 911 and executed by the CPU 911. That is, the program causes the computer to function as a “part” referred to in the description of this embodiment. Alternatively, the program causes the computer to execute the procedure or method of a “part” referred to in the description of this embodiment.

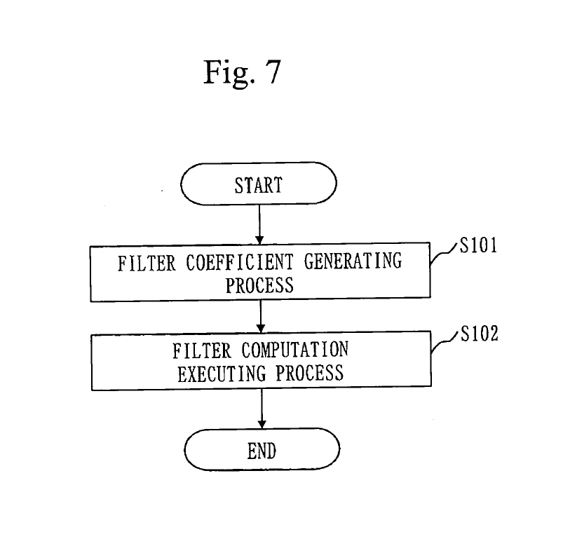

FIG. 7 is a flowchart illustrating the operation (a probe data processing method according to this embodiment, or a processing procedure of a program according to this embodiment) of the probe data processing apparatus 102.

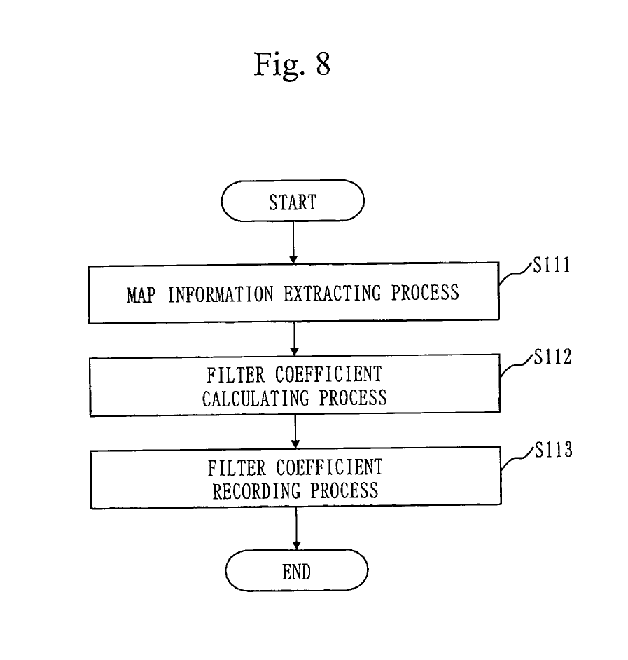

Step S101 is a process of calculating the filter coefficients beforehand. This process is executed, for example, when the map information is updated, or when a new tallying target is added to the map information. This process will be described later in detail with reference to FIG. 8.

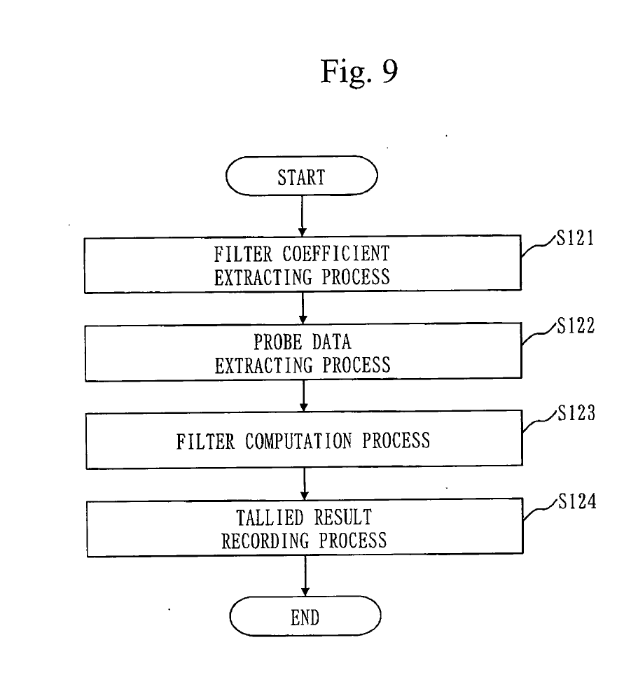

Step S102 is a process of tallying the probe data using the filter coefficients calculated in step S101. This process is executed, for example, when the data request responding part 128 produces a tallying request for specific map information, or when updating the tallied result recording part 127 regularly. This process will be described later in detail with reference to FIG. 9.

The operation of a filter coefficient generating process according to this embodiment will be described below with reference to FIG. 8.

In step S111, the filter coefficient calculating part 124 extracts map information for which filter coefficients are to be generated, from the map information recording part 122.

In step S112, for the map information extracted in step S111, the filter coefficient calculating part 124 calculates filter coefficients in accordance with the parameter recorded by the filter design information recording part 123.

In step S113, the filter coefficient calculating part 124 links the filter coefficients calculated in step S112 to the map information used for filter coefficient calculation, and records the filter coefficients by the filter coefficient recording part 125.

The operation of a filter computation executing process according to this embodiment will be described below with reference to FIG. 9.

In step S121, the filter computation processing part 126 extracts the filter coefficients corresponding to the map information to be treated as the tallying target, from the filter coefficient recording part 125.

In step S122, for each filter coefficient extracted in step S121, the filter computation processing part 126 extracts probe data to be treated as the tallying target from the data recording part 121.

In step S123, for the pairs of filter coefficients extracted in step S121 and probe data extracted in step S122 and corresponding to the respective filter coefficients, the filter computation processing part 126 practices the tallying process of the probe data using the filter coefficients as weight.

In step S124, the filter computation processing part 126 links the tallied result calculated in step S123 to the map information linked to the filter coefficients, and records the tallied result by the tallied result recording part 127.

In this embodiment, the probe data processing apparatus 102 performs the tallying process by filter computation. Hence, an effect can be obtained that even if the relation of the probe data and map information includes uncertainty, tallying is enabled without impairing the information quantity of the probe data. At the same time, an effect can be obtained that tallying with a high-resolution spatial granularity is enabled.

Also, the probe data processing apparatus 102 calculates and records the filter coefficients beforehand. Hence, an effect can be obtained that the calculation load in the filter computing process can be suppressed even if the map information has a high resolution.

With the above operation, in probe data tallying, an effect can be obtained that tallying with a high-resolution spatial granularity is enabled and high-precision tallying is enabled by suppressing loss of the information quantity of the probe data.

As described above, the probe data processing apparatus 102 according to this embodiment associates the map information and the probe data with each other by filter computation, and tallies the probe data. Thus, convenience in probe data tallying increases. In particular, in probe data tallying, tallying with a high-resolution spatial granularity is enabled. Also, high-precision tallying is enabled by suppressing loss of the information quantity of the probe data.

As described above, the probe data processing apparatus 102 may calculate and record beforehand the filter coefficients to be used for filter computation.

When recording the filter coefficients, the probe data processing apparatus 102 may exclude a grid used less frequently from being recorded.

When recording the filter coefficients, the probe data processing apparatus 102 may collate the filter coefficients sequentially, starting with a grid having a small filter coefficient.

When recording the filter coefficients, the probe data processing apparatus 102 may collate the filter coefficients sequentially, starting with a grid having a high likelihood, using a binary tree.

When calculating the filter coefficients, the probe data processing apparatus 102 may adjust the calculation parameters of the filter coefficients based on the map information.

The probe data processing apparatus 102, for example, uses as the map information, information including at least latitude-longitude information representing a road, and uses as the probe data, data including at least the latitude, longitude, and speed, to estimate the speed distribution by treating distances defined by the latitude and longitude, as the filter coefficients.

The probe data processing apparatus 102 may use information including the speed limit, as the map information, and rapidly increase the filter coefficient of the probe data having speed information that exceeds the speed limit.

As described above, the probe data processing apparatus 102 can be employed for estimation of the vehicle traffic information.

In this case, the information to be treated as the tallying process target is traffic information. Hence, the data recording part 121 preferably records, as the tallying target data, the vehicle speed, the time required for passing on a specific road, a traffic jam degree estimated by an on-vehicle camera or from the number of start/stop times, and the like. As the map data, the data recording part 121 preferably records the latitudes and longitudes of the points where the data was measured, the traveling direction for specifying the inbound and outbound lanes, and the like, so that the map data can be associated with the road. Furthermore, the data recording part 121 preferably records the road type such as highway, regular road, and the like, the vehicle type information for separating difference due to the vehicle types, and the like, so that the tallying precision improves.

Meanwhile, naturally, the traffic information may be tallied along the road. Accordingly, the map information recording part 122 preferably records the latitudes and longitudes of points that constitute the road, the lane direction for specifying the inbound and outbound lanes, and the like. Furthermore, the map information recording part 122 preferably records the road type such as highway, regular road, and the like, the speed limit information which serves for excluding a vehicle exceeding the speed limit from tallying, and the like, so that the tallying precision improves.

In traffic information tallying, preferably, the road condition of the tallying target and the collecting condition of the probe data coincide. Hence, the filter coefficient calculating part 124 preferably calculates a distance weighted with the distance between the probe data and the latitude and longitude of the road, the matching degree of the lane direction and the traveling direction, and the matching degrees of various other types of road information, using the map information. Also, in order to exclude inappropriate data from the tallying target, for data of a matching degree indicating a gap of a predetermined degree or more, or data beyond the speed limit, the filter coefficient calculating part 124 preferably conducts a process that increases the distance rapidly.

The filter design information recording part 123 preferably can specify the parameter for each road so that these conditions can be adapted flexibly. For example, the distance from the road is determined for narrow ranges in the urban area and for wide ranges in the rural area. This enables tallying with a high-resolution granularity in the urban area where the map precision is high, while loss of the information quantity due to an error can be suppressed in the rural area where the map precision is comparatively low.

Regarding the filter computation processing part 126, the computing process of a statistic such as a mean value is effective. Also, as a situation peculiar to the traffic information, discontinuous phenomena such as waiting for a traffic light, waiting to turn right, and the like are raised. Therefore, in particular, distribution estimation and histogram calculating process are preferable.

With the above operations, an effect can be obtained that traffic information can be estimated with a high-resolution granularity from the probe data.

An embodiment of the present invention has been described above. Note that the present invention is not limited to this embodiment, but various modifications can be made as necessary.

### REFERENCE SIGNS LIST

100: probe data processing system; 101: probe; 102: probe data processing apparatus; 103: probe-data using server; 110: sensors; 111: data transmitting part; 120: data receiving part; 121: data recording part; 122: map information recording part; 123: filter design information recording part; 124: filter coefficient calculating part; 125: filter coefficient recording part; 126: filter computation processing part; 127: tallied result recording part; 128: data request responding part; 901: LCD; 902: keyboard; 903: mouse; 904: FDD; 905: CDD; 906: printer; 911: CPU; 912: bus; 913: ROM; 914: RAM; 915: communication board; 920: HDD; 921: operating system; 922: window system; 923: programs; 924: files

1-11. (canceled)

12. A probe data processing apparatus comprising:
a data recording circuit that records a plurality of pieces of probe data generated by a probe which observes a traffic jam degree and indicating observation positions and observed traffic jam degrees, to a storage device;
a filter coefficient recording circuit that segments a geographic range including a road for which a traffic jam degree is to be calculated, into a plurality of regions such that not less than one region out of the plurality of regions includes the road, associates filter coefficients determined depending on distances between a line formed by the road and the plurality of regions, with the plurality of regions, respectively, and records the filter coefficients to the storage device; and
a filter computation processing circuit that reads the plurality of pieces of probe data recorded by the data recording circuit and the filter coefficients recorded by the filter coefficient recording circuit, from the storage device, calculates a traffic jam degree of the road from the traffic jam degrees indicated by the plurality of pieces of probe data and the filter coefficients associated with regions where exist the observation positions indicated by the plurality of pieces of probe data, out of the plurality of regions, and outputs the calculated traffic jam degree of the road.

13. The probe data processing apparatus according to claim 12, wherein the filter computation processing circuit weights the traffic jam degrees indicated by the plurality of pieces of probe data with the filter coefficients associated with the regions where exist the observation positions indicated by the plurality of pieces of probe data, respectively, tallies the weighted traffic jam degrees, and outputs a tallied result as the traffic jam degree of the road.

14. The probe data processing apparatus according to claim 12,
wherein the plurality of pieces of probe data are pieces of data each further indicating an attribute of an observation location,
wherein the filter coefficient recording circuit associates the filter coefficients determined depending on distances between an attribute of the road and a plurality of attributes, in addition to the distances between the line and the plurality of regions, with combinations of the plurality of regions and the plurality of attributes, respectively, and records the filter coefficients, and
wherein the filter computation processing circuit calculates the traffic jam degree of the road from the traffic jam degrees indicated by the plurality of pieces of probe data and the filter coefficients associated with combinations of the regions where exist the observation positions indicated by the plurality of pieces of probe data, out of the plurality of regions, and an attribute that matches the attribute of the observation location indicated by the plurality of probe data, out of the plurality of attributes, and outputs the calculated traffic jam degree of the road.

15. The probe data processing apparatus according to claim 12, wherein
the filter coefficient recording circuit, with respect to a region which is at a certain distance or more from the line, excludes a filter coefficient from being recorded.

16. The probe data processing apparatus according to claim 12, wherein the filter computation processing circuit extracts regions corresponding to the observation positions indicated by the plurality of pieces of probe data, respectively, out of the plurality of regions, by collating the plurality of regions to the observation positions indicated by the plurality of pieces of probe data, in an ascending order of the filter coefficients recorded by the filter coefficient recording circuit.

17. The probe data processing apparatus according to claim 12, wherein the plurality of regions are set to have different sizes depending on a geographic condition.

18. A probe data processing system comprising:
the probe data processing apparatus according to claim 12; and
the probe which generates the plurality of pieces of probe data.

19. A probe data processing apparatus comprising:
a data recording circuit that records a plurality of pieces of probe data generated by a probe which observes a speed of a vehicle and indicating observation positions and observed speeds, to a storage device;
a filter coefficient recording circuit that segments a geographic range including a road for which a speed of a vehicle is to be calculated, into a plurality of regions such that not less than one region out of the plurality of regions includes the road, associates filter coefficients determined depending on distances between a line formed by the road and the plurality of regions, with the plurality of regions, respectively, and records the filter coefficients to the storage device; and
a filter computation processing circuit that reads the plurality of pieces of probe data recorded by the data recording circuit and the filter coefficients recorded by the filter coefficient recording circuit, from the storage device, calculates a speed of a vehicle traveling on the road from the speeds indicated by the plurality of pieces of probe data and the filter coefficients associated with regions where exist the observation positions indicated by the plurality of pieces of probe data, out of the plurality of regions, and outputs the calculated speed of the vehicle traveling on the road.

20. The probe data processing apparatus according to claim 19, wherein the filter coefficient recording circuit, with respect to a region which is at a certain distance or more from the line, excludes a filter coefficient from being recorded.

21. The probe data processing apparatus according to claim 19, wherein the filter computation processing circuit extracts regions corresponding to the observation positions indicated by the plurality of pieces of probe data, respectively, out of the plurality of regions, by collating the plurality of regions to the observation positions indicated by the plurality of pieces of probe data, in an ascending order of the filter coefficients recorded by the filter coefficient recording circuit.

22. The probe data processing apparatus according to claim 19, wherein the plurality of regions are set to have different sizes depending on a geographic condition.

23. A probe data processing system comprising:
the probe data processing apparatus according to claim 19; and
the probe which generates the plurality of pieces of probe data.

24. A probe data processing method comprising:
recording a plurality of pieces of probe data generated by a probe which observes a traffic jam degree and indicating observation positions and observed traffic jam degrees, to a storage device;
segmenting a geographic range including a road for which a traffic jam degree is to be calculated, into a plurality of regions such that not less than one region out of the plurality of regions includes the road, associating filter coefficients determined depending on distances between a line formed by the road and the plurality of regions, with the plurality of regions, respectively, and recording the filter coefficients to the storage device; and
reading the plurality of pieces of probe data and the filter coefficients from the storage device, calculating a traffic jam degree of the road from the traffic jam degrees indicated by the plurality of pieces of probe data and the filter coefficients associated with regions where exist the observation positions indicated by the plurality of pieces of probe data, out of the plurality of regions, and outputting the calculated traffic jam degree of the road.

25. A probe data processing method comprising:
recording a plurality of pieces of probe data generated by a probe which observes a speed of a vehicle and indicating observation positions and observed speeds, to a storage device;
segmenting a geographic range including a road for which a speed of a vehicle is to be calculated, into a plurality of regions such that not less than one region out of the plurality of regions includes the road, associating filter coefficients determined depending on distances between a line formed by the road and the plurality of regions, with the plurality of regions, respectively, and recording the filter coefficients to the storage device; and
reading the plurality of pieces of probe data and the filter coefficients from the storage device, calculating a speed of a vehicle traveling on the road from the speeds indicated by the plurality of pieces of probe data and the filter coefficients associated with regions where exist the observation positions indicated by the plurality of pieces of probe data, out of the plurality of regions, and outputting the calculated speed of the vehicle traveling on the road.

26. A non-transitory computer readable medium including a computer executable program that causes a computer to execute:
a data recording process of recording a plurality of pieces of probe data generated by a probe which observes a traffic jam degree and indicating observation positions and observed traffic jam degrees, to a storage device;
a filter coefficient recording process of segmenting a geographic range including a road for which a traffic jam degree is to be calculated, into a plurality of regions such that not less than one region out of the plurality of regions includes the road, associating filter coefficients determined depending on distances between a line formed by the road and the plurality of regions, with the plurality of regions, respectively, and recording the filter coefficients to the storage device; and
a filter computing process of reading the plurality of pieces of probe data recorded by the data recording process and the filter coefficients recorded by the filter coefficient recording process, from the storage device, calculating a traffic jam degree of the road from the traffic jam degrees indicated by the plurality of pieces of probe data and the filter coefficients associated with regions where exist the observation positions indicated by the plurality of pieces of probe data, out of the plurality of regions, and outputting the calculated traffic jam degree of the road.

27. A non-transitory computer readable medium including a computer executable program that causes a computer to execute:
a data recording process of recording a plurality of pieces of probe data generated by a probe which observes a speed of a vehicle and indicating observation positions and observed speeds, to a storage device;
a filter coefficient recording process of segmenting a geographic range including a road for which a speed of a vehicle is to be calculated, into a plurality of regions such that not less than one region out of the plurality of regions includes the road, associating filter coefficients determined depending on distances between a line formed by the road and the plurality of regions, with the plurality of regions, respectively, and recording the filter coefficients to the storage device; and
a filter computing process of reading the plurality of pieces of probe data recorded by the data recording process and the filter coefficients recorded by the filter coefficient recording process, from the storage device, calculating a speed of a vehicle traveling on the road from the speeds indicated by the plurality of pieces of probe data and the filter coefficients associated with regions where exist the observation positions indicated by the plurality of pieces of probe data, out of the plurality of regions, and outputting the calculated speed of the vehicle traveling on the road.
